(19) United States
(12) Patent Application Publication
(10) Pub. No.: US 2018/0094533 A1
(43) Pub. Date: Apr. 5, 2018

(54) DEVICE FOR DETECTING THE ROTATIONAL ANGLE OF ADJUSTABLE GUIDE VANES

(71) Applicant: Siemens Aktiengesellschaft, Munich (DE)

(72) Inventors: Hans-Georg Gamm, Dinslaken (DE); Ulrich Waltke, Mülheim an der Ruhr (DE)

(73) Assignee: Siemens Aktiengesellschaft, Munich (DE)

(21) Appl. No.: 15/563,252

(22) PCT Filed: Feb. 24, 2016
(86) PCT No.: PCT/EP2016/053875

§ 371 Date: Sep. 29, 2017

(30) Foreign Application Priority Data
Apr. 7, 2015 (EP) 15162591.0

(51) Int. Cl. F01D 17/02; F02C 9/22; F01D 17/20; F04D 27/02; F01D 21/00; F04D 27/00; F04D 29/56; F01D 17/16

(52) U.S. Cl. CPC F01D 17/02; F02C 9/22; F01D 17/20; F01D 17/162; F01D 21/003; F04D 27/001; F04D 29/563; F04D 27/0246

(57) ABSTRACT

A device for detecting the rotational angle of the position of a plurality of adjustable guide vanes of a gas turbine, has at least three rotational angle sensors at different locations of the gas turbine, wherein the rotational angle sensors are designed to measure the rotational angle of guide vanes at the respective locations, and has an analyzing unit which is designed to calculate at least three rotational angle changes between each set of two different rotational angle sensors and to provide the at least three rotational angle changes.

### CROSS REFERENCE TO RELATED APPLICATIONS

This application is the US National Stage of International Application No. PCT/EP2016/053875 filed Feb. 24, 2016, and claims the benefit thereof. The International Application claims the benefit of European Application No. EP15162591 filed Apr. 7, 2015. All of the applications are incorporated by reference herein in their entirety.

### FIELD OF INVENTION

The present invention relates to a device for sensing the rotational angle of the position of a plurality of settable guide vanes, and to a gas turbine comprising such a device.

### BACKGROUND OF INVENTION

Guide vanes of a gas turbine can be set, by appropriate selection of the rotational angle, for the purpose of regulating the quantity of intake air. The alteration of the rotational angle of the guide vanes in this case can be effected by a variety of mechanical devices. A typical mechanism known from the prior art, for instance, by means of a rotation ring (also referred to as an adjustment ring) that can be displaced in the circumferential direction of the housing of the gas turbine, perpendicularly in relation to the direction of longitudinal extent of the gas turbine rotor, enables all guide vanes of a guide vane stage to be set simultaneously. The guide vanes in this case are coupled to the rotation ring by a suitable mechanical transmission mechanism.

In the operation of such mechanical devices, however, it has frequently been found that setting of the rotational angle of the guide vanes of a guide vane stage cannot be effected evenly, or uniformly. This is because a mechanical displacement, or a material deformation, for instance of the mechanical device, causes the motion of the latter to be unevenly transmitted to the individual guide vanes. As a consequence, however, differing flow states may ensue over the cross section of the intake flow channel of the gas turbine, resulting in a disadvantageous distribution of the intake air flow and of the load on the rows of rotor vanes in the compressor of the gas turbine that are adjacent to the row of guide vanes, and are therefore to be avoided.

From the internal prior art known to the applicant, the current rotational angle settings of the guide vanes of a stage are sensed by appropriate rotational angle sensors. Thus, for instance, two of these rotational angle sensors are mounted on opposite sides of the gas turbine, and sense the adjustment of the guide vanes by means of an appropriate coupling to the adjusting mechanism. Specifically, the two rotational angle sensors are connected, for instance, directly or indirectly to the guide vanes, and sense a change in angle when the latter is displaced in the circumferential direction. Thus, upon the adjustment of the adjusting device, the two sensors can each sense a rotational angle, and a mean adjustment of the guide vanes can be inferred, for instance, from the comparison of the two rotational angles.

It has been found, however, in the operation of such an adjusting mechanism, that not only may the rotation sensors possibly deliver incorrect values, but that the adjusting device may also be responsible for a deviation of the two measurements, for instance owing to a mechanical deformation, or unwanted changes in the position. Owing to these variations, however, in some cases a useful mean rotational angle setting of the guide vanes can no longer be inferred on the basis of the comparison of the measured rotational angles. In particular, however, if a rotational angle sensor is damaged, a mean adjustment of the guide vanes can thus no longer be inferred in a reliable manner. Nor may it be possible to correctly identify the defective rotational angle sensor, such that, for instance, the latter may remain unconsidered in the measurements that are performed.

The provision of redundant rotational angle sensors at a mounting location, for instance for the purpose of identifying defective rotational angle sensors, also proves to be disadvantageous, since it is necessary for a significantly greater number of rotational angle sensors to be held in reserve. Moreover, such redundant rotational angle sensors do not allow correct identification of the mechanical deformation, for instance of the device for setting the rotational angle of the guide vanes.

Consequently, there arises the technical requirement to propose a suitable device, for sensing the rotational angle of the position of settable guide vanes on the gas turbine, that can avoid the disadvantages, described above, from the prior art. In particular, there arises the technical requirement to propose a device for rotational angle sensing that also allows defective rotational angle sensors in this device to be identified without difficulty. The device is also to be able to distinguish between a measurement result achieved by a defective rotational angle sensor and a measurement result that results, for instance, from mechanical deformation of the components of the mechanical adjusting device.

### SUMMARY OF INVENTION

This object, on which the invention is based, is achieved by a device and by a gas turbine according to the claims.

In particular, the objects on which the invention is based are achieved by a device for sensing the rotational angle of the position of a plurality of settable guide vanes of a gas turbine, comprising at least three rotational angle sensors at mutually differing locations on the gas turbine, which are designed to measure the rotational angle of guide vanes at the respective locations, and furthermore comprising an evaluation unit that is designed to calculate at least three rotational angle changes between respectively two differing rotational angle sensors, and to provide the at least three rotational angle changes.

Furthermore, the objects on which the invention are based are achieved by a gas turbine, comprising such a device, described above and also in the following, for sensing the rotational angle of the position of a plurality of settable guide vanes of a gas turbine.

The core of the invention consists, firstly, in that at least three rotational angle sensors, that are each attached to differing locations on the gas turbine, are to be comprised by the device for sensing the rotational angle. Three respectively independent rotational angle measurements can thereby be effected, in the sense of independent degrees of freedom, that can be compared with each other.

Furthermore, the invention provides that the results of these at least three rotational angle measurements be used in a calculation procedure, in order to calculate, in turn, at least three rotational angle changes. These rotational angle changes are obtained by comparison of respectively two differing measured rotational angles. Should more than three rotational angles be measured, more than two rotational angles could also be included in these rotational angle changes for the purpose of calculation. These calculations are performed in an evaluation unit that, after calculation of the at least three rotational angle changes has been effected, can provide these for further use.

Owing to the calculation of the rotational angle changes instead of absolute rotational angles, there are at least three measurement values in total, which each relate at least two, or precisely two, differing measurement locations to each other. On the basis of this relationship it is possible, for instance in the case of fault of a rotational angle sensor, to identify this fault in a relatively reliable manner, namely in that two rotational angle changes are affected to a comparatively greater extent by this fault, but the third is affected to a comparatively lesser extent. The at least three rotational angle changes therefore also differ from measurement results that result, for instance, from a geometric deformation of the components of the mechanical adjusting mechanism. In the case of a deformation or, also, unwanted change in the position of these components, in particular, for instance, of the rotation ring, a set of rotational angle changes ensues that differs significantly, for instance, from a set of rotational angle changes of fault-free standard measurement. Likewise, the set of rotational angle changes also differs from a set of such rotational angle changes that were calculated following damage to a rotational angle sensor. Owing to the effects of the individual factors on this set of rotational angle changes, to be explained in greater detail below, the operator is able to discriminate between differing operating problems on the basis of the characteristics of the set and, depending on the incident, initiate an appropriate measure.

At this point, attention must be drawn to the fact that the position, according to the invention, of the plurality of settable guide vanes relates to a rotational position, the associated rotational axis typically, in the case of normal operation of the gas turbine, being substantially perpendicular, or almost perpendicular, to the direction of longitudinal extent of the gas turbine. Moreover, the guide vanes according to the invention are mounted in a fixed manner in the gas turbine, i.e. they cannot execute a rotational motion together with the gas turbine rotor, as can, for instance, the rotor vanes. The guide vanes serve merely to effect fixed conditioning of the intake air stream, and can be rotated in such a manner that the angle of attack of the subsequent guide vane row, and consequently the aerodynamic load thereof, can be altered. The guide vanes in this case may be both inlet guide vanes, i.e. guide vanes of a first guide vane stage in the gas turbine, and those of a downstream guide vane stage.

Furthermore, attention must be drawn to the fact that a rotational angle change is typically calculated by subtraction of the individual measured rotational angles. Depending on the choice of definition of the rotational angles, subtraction of the amount of individual rotational angles of the individual rotational angle sensors may be appropriate for calculation of a rotational angle change. Advantageously, however, this calculation of the rotational angle change is performed without further weighting of the individual rotational angles. For the purpose of definition of the rotational angle, however, it is necessary that a corresponding comparison value, or reference value, of the angular position is also available at each instant of a measurement of a rotational angle. This may be, for example, a zero position of the rotational angle sensor that was defined beforehand. Appropriate calibration measurements for this may be performed at the time of commissioning of the gas turbine. However, this comparison value, or reference value, may also be changed, or redefined, in the course of operation of a gas turbine. Then, however, the calculations of the respective rotational angle changes take account of such a redefinition.

According to a first embodiment of the invention, it is provided that the at least three rotational angle sensors are arranged in a sectional plane perpendicular to the direction of longitudinal extent of the gas turbine rotor. Consequently, sensing of differing rotational angles can be effected in the cross-sectional plane, and possible operating problems that relate to a single guide vane stage can be sensed rapidly. Such an arrangement proves to be advantageous, in particular, if the guide vanes that intersect the sectional plane can be actuated by a common adjusting mechanism, since in this way geometric deformations or changes in position of this adjusting mechanism can be sensed in a selective manner.

Furthermore, it is provided, according to an advantageous aspect of the invention, that the at least three rotational angle sensors are each mounted on a transmission part that is directly, or also indirectly, mechanically coupled to a plurality of guide vanes. Advantageously, the transmission part is coupled to all guide vanes of a stage, in that, for instance, the rotational motion of all of these guide vanes can be initiated by a suitable adjusting device, for instance a rotation ring (adjusting ring) surrounding the gas turbine, this adjusting device, in turn, being directly, or also indirectly, coupled to the transmission part.

Alternatively, or also additionally, the transmission part may also be rotationally mechanically coupled to a predefined guide vane, such that, upon rotation of this guide vane, a rotational angle can be sensed by the rotational angle sensor. The transmission part according to the embodiment allows secure mounting of the respective rotational angle sensor. In particular, as a result of provision of the transmission part, a geometric deformation, or an altered position, of individual components of the adjusting device can be sensed by measurement means, since, as a result of acting in combination with the transmission part, those guide vanes that are not directly coupled to the respective transmission part can also affect a rotational angle measurement.

Furthermore, it proves to be advantageous if, according to a further embodiment of the invention, the at least three rotational angle sensors are arranged on the compressor of the gas turbine. Advantageously, there are precisely three rotational angle sensors.

According to a further embodiment of the invention, it is provided that precisely three rotational angle sensors are provided, that are each arranged with an angular offset of 120° in relation to the adjacent rotational angle sensors in the circumferential direction perpendicular to the direction of longitudinal extent of the gas turbine rotor. This geometric arrangement makes it possible, in particular, to sense the influence of the deformation, or a geometric change of position, of individual components of the mechanical adjusting device, such as, for instance, the rotation ring. In particular, an eccentric displacement of the rotation ring can thus be detected. It is thus found, in particular, that characteristic sets of rotational angle changes occur as a result of such geometric deformations, or changes of position, which are easily identifiable on the basis of their characteristic type.

As an alternative to this embodiment, it may also be provided that precisely three rotational angle sensors are provided, wherein two rotational angle sensors are arranged with an angular offset of 180° in relation to each other in the circumferential direction perpendicular to the direction of longitudinal extent of the gas turbine rotor, and the third rotational angle sensor has, in relation to the two other rotational angle sensors, respectively, an angular offset of 90° in the circumferential direction perpendicular to the direction of longitudinal extent of the gas turbine rotor. With such a constellation, the two rotational angle sensors arranged with an angular offset of 180° in relation to each other are particularly well suited, when their measurements are compared with each other, to being able to detect a possible case of damage to one of the two rotational angle sensors. The third rotational angle sensor, which is arranged at 90° in the circumferential direction in comparison with the two other rotational angle sensors, serves primarily to identify geometric deformations, or changes of position, of individual components of the gas turbine. Nevertheless, the three rotational angle sensors according to the embodiment continue to work together in such a manner that a predefined operating state can be inferred from the respective rotational angle changes that are calculated in the evaluation unit.

According to a further advantageous embodiment of the invention, it is provided that the evaluation unit is designed to output a warning signal if two rotational angle changes have increased more than a predefined first change quantity, and one rotational angle change has decreased more than a predefined second change quantity. As explained in greater detail further below, this characteristic of rotational angle changes ensues primarily in the case of damage to a rotational angle sensor. To that extent, the characteristic allows the operator to identify that there is a high probability that one of the rotational angle sensors must be replaced, this replacement to be performed accordingly at the next service. The warning signal thus signals to the operator that it is highly probable that a rotational angle sensor has sustained damage, while a geometric deformation, or change of position, of individual components of the adjusting device can largely be precluded.

According to a development of this embodiment, it may be provided that the evaluation unit is designed to leave out of consideration from future calculations the rotational angle sensor that has contributed to the two rotational angle changes that have increased more than a predefined first change quantity. In other words, the evaluation unit can change to leaving the possibly damaged rotational angle sensor out of consideration in further calculations of the evaluation unit. Consequently, for instance, there may be no change to the operation of the gas turbine if it is established with a relatively large degree of certainty that only one rotational angle sensor has sustained damage, and there are not more serious problems for the operation of the gas turbine. Advantageously, on the basis of this distinction, there may be no need for emergency switch-off of the gas turbine, which would be performed in the case of certain damage characteristics.

The invention is to be described in greater detail in the following on the basis of individual figures. It must be pointed out in this case that the components shown in the figures are to be understood as being merely schematic, and a lack of practicability cannot be established on the basis of this schematic representation.

Furthermore, it must be pointed out that the features represented in the following may be claimed in any combination with each other insofar as they are able to achieve the object on which the invention is based.

Likewise, it must be pointed out that technical features that are denoted by the same references are intended to have the same technical effect.

### BRIEF DESCRIPTION OF THE DRAWINGS

There are shown in:

FIG. 1 a detail of a first embodiment of a device according to the invention for rotational angle sensing, in a cross-sectional view perpendicular to the direction of longitudinal extent of the gas turbine rotor of a gas turbine;

FIG. 2 a perspective view of a rotational angle sensor, such as that comprised, for instance, by the device for rotational angle sensing shown in FIG. 1;

FIG. 3 a schematic representation of a further embodiment of the device according to the invention for rotational angle sensing, in a cross-sectional view perpendicular to the direction of longitudinal extent of the gas turbine rotor of a gas turbine following change of position of a rotation ring of the gas turbine;

FIG. 4 a schematic representation of the at least three rotational angle changes in comparison following corresponding calculation on the basis of measurements that result, for instance, in the case of geometric displacement of the rotation ring, as represented in FIG. 3.

FIG. 5 a schematic representation of the at least three rotational angle changes in comparison following corresponding calculation on the basis of measurements that result, for instance, following damage to a rotational angle sensor.

### DETAILED DESCRIPTION OF INVENTION

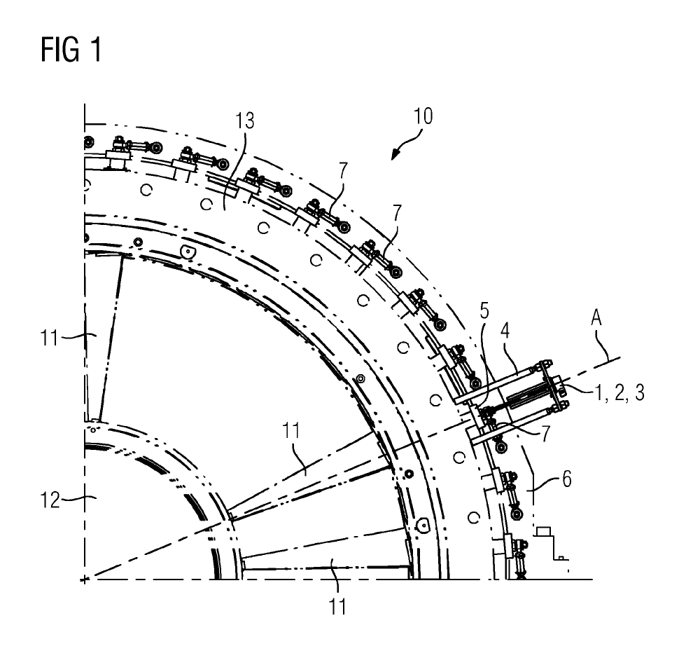

FIG. 1 shows a quadrant of a cross section through an embodiment of a gas turbine 10 according to the invention perpendicular to the direction of longitudinal extent of the gas turbine rotor 12. In other words, the cross-sectional view shown thus shows only ¼ of the gas turbine rotor 12 of the gas turbine 10 shown.

The shown cross section in this case relates to the compressor 13, located in which there is a stage of guide vanes 11, which are arranged in a fixed manner around the gas turbine rotor 12. Despite their fixed position, the guide vanes 11 can be rotated with respect to the gas turbine rotor 12, a corresponding rotation being effected about a rotation axis A, shown exemplarily. One of the rotational angle sensors 1, 2, 3 is arranged in an extension of such an axis A. The rotation of the individual guide vanes 11 is effected by a hydraulically driven rotation ring 6, the motion of which is converted into a rotational motion by individual transmission rods 7 and, respectively, a transmission part 5, in the region of the foot of a guide vane 11.

The rotation ring 6 in this case, for its part, is moved hydraulically, by a selective motion in the circumferential direction (i.e. perpendicular to the rotation axis A), in the shown plane of the drawing of the figure. As a result of the motion, which is then transmitted as a rotational motion to the foot regions of the respective guide vanes 11, there is a selective setting of the rotational angle of the individual guide vanes 11.

In order, as has already been explained further above, to enable the rotational angle setting of the guide vanes 11 to be sensed with precision, the device for rotational angle sensing includes a total of three rotational angle sensors 1, 2, 3 (in this case, only one is shown). The rotational angle sensors 1, 2, 3 are arranged on a suitably designed holding device 4, which, like the guide vanes 11 themselves, is fixedly mounted in or on the housing of the gas turbine 10. If the rotation ring 6 is then moved, the mechanical operative connections of the individual components result in a corresponding rotation of the transmission part 5 about the rotation axis A, as a result of which, likewise, corresponding rotational angle setting of the rotational angle sensor 1, 2, 3 concerned is effected. By appropriate read-out of the thus sensed rotational angles D1, D2, D3, a set of rotational angle changes Δ12, Δ23, Δ13 can be calculated by means of the evaluation unit 20, in that, for instance, the sensed rotational angles D1, D2, D3 are subtracted from each other. Depending on the characteristic of the thus sensed set of rotational angle changes Δ12, Δ23, Δ13, inferences can be drawn concerning the state of the rotational angle sensors 1, 2, 3, or also concerning geometric changes, for instance changes of position of individual components of the adjusting device, for example of the rotation ring 6.

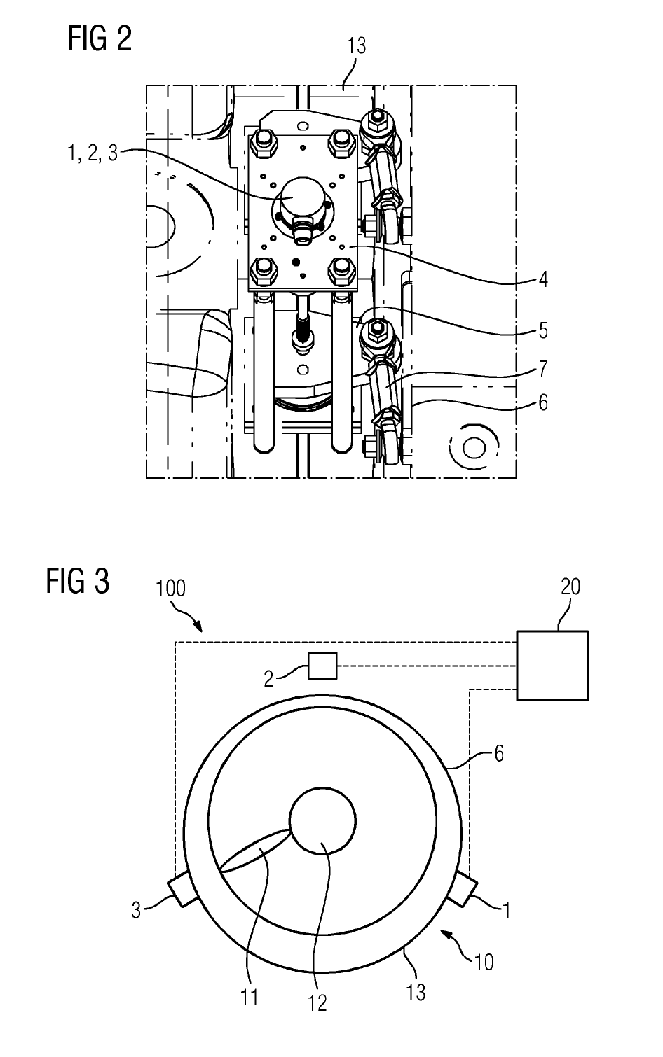

FIG. 2 shows a perspective side view of a rotational angle sensor 1, 2, 3, which is mounted in a fixed manner by a holding device 4, and which is connected in a rotationally mechanical manner to a transmission part 5 via a rod, which is not denoted by a reference. If there is an adjustment of the rotation ring 6, as already explained further above, the transmission rods 7 are moved substantially along a circumferential line of the surface of the housing of the gas turbine 10, thereby resulting in a rotation of the transmission part 5 about the rotation axis A, not shown further. This rotation is sensed, as a rotational angle D1, D2, D3, by the rotational angle sensor 1, 2, 3. By corresponding calculation of individual rotational angle changes on the basis of these measured rotational angles D1, D2, D3, a set of rotational angle changes Δ12, Δ23, Δ13 can thus be calculated that allows inferences to be drawn concerning the problems, specific to rotational angle, that are possibly occurring in operation of the gas turbine.

FIG. 3 shows a schematic side view perpendicular to the gas turbine rotor 12 of a gas turbine 10 according to a further embodiment of the invention. Included is a device 100 for sensing the rotational angle of the position of a plurality of settable guide vanes 11 (only one is indicated), precisely three rotational angle sensors 1, 2, 3 being mounted at mutually differing locations on the gas turbine. In a manner comparable to the embodiment shown in FIG. 1, the three rotational angle sensors 1, 2, 3 are able to sense in total 3 rotational angles D1, D2, D3 of the guide vanes 11, the respective rotational angles D1, D2, D3 being transmitted to an evaluation unit 20, which relates these three rotational angles D, D2, D3 to each other. From these rotational angles D1, D2, D3, the evaluation unit 20 calculates a total of three rotational angle changes Δ12, Δ23, Δ13, which it can provide for further analysis purposes. If, as shown in the present case, for example because of a change of position of the rotation ring 6, the result is then a deviation of the individual rotational angles D1, D2, D3 from those in the case of the rotation ring 6 being unchanged, a characteristic set of rotational angle changes Δ12, Δ23, Δ13 is produced, from which an operational diagnosis can identify this situation of a changed position of a rotation ring 6.

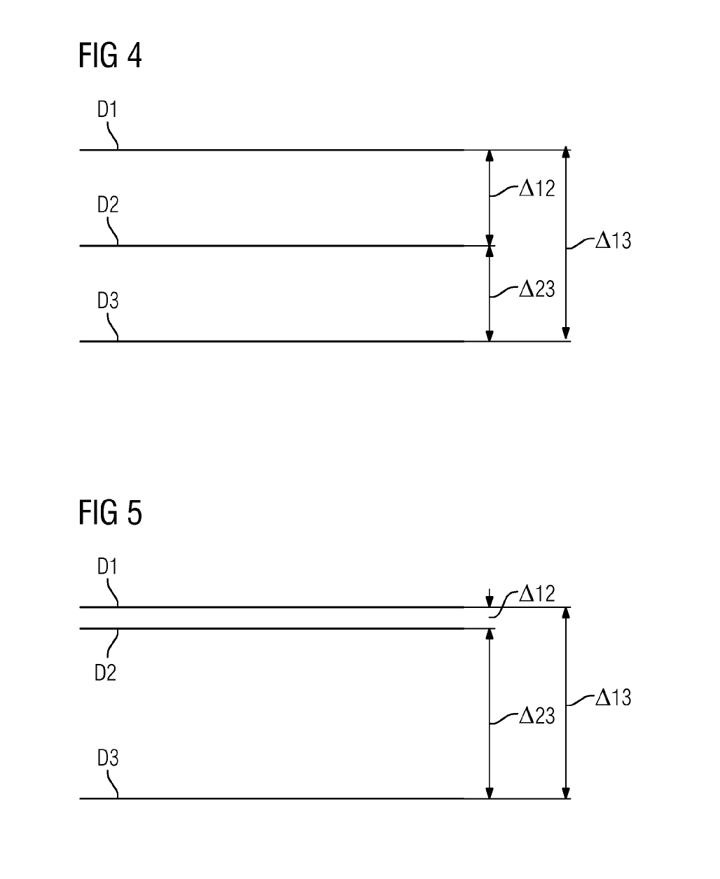

This is because, if all three rotational angle sensors 1, 2, 3 are functional, the shown change of position of the rotation ring 6 does not cause any substantial deviation of the sensed rotational angle D2 at the rotational angle sensor 2. By contrast, owing to the change of position of the rotation ring 6, the rotational angles D1 and D3 undergo an additional rotational angle component, such that both prove to be greater in amount in comparison with the normal operation without change of position of the rotation ring 6. If the set of rotational angle changes Δ12, Δ23, Δ13 is then calculated from these three rotational angles D1, D2, D3 in the evaluation unit 20, it is found, as represented in FIG. 4, that in total two rotational angle changes Δ12, Δ23 are substantially equal in amount, but differ significantly from the third rotational angle change Δ13, which is significantly greater in amount than the other two rotational angle changes Δ12 and Δ23.

In comparison with this, shown diagrammatically in FIG. 5 is the set of rotational angle changes Δ12, Δ23 and Δ13 in the case of a functional rotational angle sensor 2. This is because if, for instance, this rotational angle sensor 2 is damaged and delivers excessively large values, it outputs, for example, an excessively large rotational angle D2. Consequently, a set of rotational angle changes Δ12, Δ23 and Δ13 is produced, in which the rotational angle change Δ12 is significantly smaller in amount than the other two rotational angle changes Δ23 and Δ13. To that extent, also obtained is a characteristic of the set of rotational angle changes Δ12, Δ23 and Δ13 that differs fundamentally from that of the set of rotational angle changes represented visually in FIG. 4.

If an operator of an embodiment of the gas turbine 10 according to the invention should then wish to distinguish between operation with a non-functional sensor and operation in which, for instance, components have become geometrically displaced or deformed, it suffices for the operator to consider the set of rotational angle changes Δ12, Δ23 and Δ13. If the operator in this case finds, for instance, that two rotational angle changes are greater than a predefined first change quantity, and a third rotational angle change is less than a second change quantity, the operator can assume that a rotational angle sensor 1, 2, 3 has sustained damage. The change quantities are determined generally in the sense of a limit value, and may be defined, for instance in advance, by experiments. Depending on the embodiment of the evaluation unit 20, a corresponding warning signal may also be output in the case of such a constellation. Moreover, following identification of the damaged rotational angle sensor, the operator may remove it from future measurement analyses. It is likewise conceivable that the evaluation unit 20 itself already automatically effects such an exclusion of the damaged rotational angle sensor.

Further embodiments are disclosed by the dependent claims.

1. A device for sensing the rotational angle of the position of a plurality of settable guide vanes of a gas turbine, comprising:
at least three rotational angle sensors at mutually differing locations on the gas turbine, which are designed to measure the rotational angle of guide vanes at the respective locations, and
an evaluation unit that is designed to calculate at least three rotational angle changes between respectively two differing rotational angle sensors, and to provide the at least three rotational angle changes.

2. The device as claimed in claim 1,
wherein the at least three rotational angle sensors are arranged in a sectional plane perpendicular to the direction of longitudinal extent of the gas turbine rotor.

3. The device as claimed in claim 1,
wherein the at least three rotational angle sensors are each mounted on a transmission part that is directly, or also indirectly, mechanically coupled to a plurality of guide vanes.

4. The device as claimed in claim 1,
wherein the at least three rotational angle sensors are arranged on the compressor of the gas turbine.

5. The device as claimed in claim 1,
wherein precisely three rotational angle sensors are provided, that are each arranged with an angular offset of 120° in relation to the respectively adjacent rotational angle sensors in the circumferential direction perpendicular to the direction of longitudinal extent of the gas turbine rotor.

6. The device as claimed in claim 1,
wherein precisely three rotational angle sensors are provided,
wherein two rotational angle sensors are arranged with an angular offset of 180° in relation to each other in the circumferential direction perpendicular to the direction of longitudinal extent of the gas turbine rotor, and the third rotational angle sensor has, in relation to the two other rotational angle sensors, respectively, an angular offset of 90° in the circumferential direction perpendicular to the direction of longitudinal extent of the gas turbine rotor.

7. The device as claimed in claim 1,
wherein the evaluation unit is designed to output a warning signal if two rotational angle changes have increased more than a predefined first change quantity, and one rotational angle change has decreased more than a predefined second change quantity.

8. The device as claimed in claim 7,
wherein the evaluation unit is designed to leave out of consideration from future calculations the rotational angle sensor that has contributed to the two rotational angle changes that have increased more than a predefined first change quantity.

9. A gas turbine, comprising:
such a device for sensing the rotational angle of the position of a plurality of settable guide vanes of a gas turbine as claimed in claim 1.
